(19) United States
(12) Patent Application Publication
(10) Pub. No.: US 2022/0027464 A1
(43) Pub. Date: Jan. 27, 2022

(54) SYSTEMS AND METHODS FOR CONSTRAINING ACCESS TO ONE TIME PROGRAMMABLE STORAGE ELEMENTS

(71) Applicant: NXP USA, Inc., AUSTIN, TX (US)

(72) Inventors: Markus Regner, Munich (DE); Stefan Doll, Muenchen (DE); Marcus Mueller, Munich (DE)

(21) Appl. No.: 16/936,630

(22) Filed: Jul. 23, 2020

(51) Int. Cl. G06F 21/55; G06F 21/78

(52) U.S. Cl. CPC G06F 21/554; G06F 2221/034; G06F 21/78

(57) ABSTRACT

A circuit includes a one-time programmable (OTP) storage element configured to store a first logic value, an access delay timer configured to initiate a timer in response to a reset event with a timer value, and an access control circuit coupled to the access delay timer and the OTP storage element. The access control circuit is configured to count a number of access requests to the OTP storage element granted by the access control circuit and to store the number of granted access requests to the OTP storage element as a count value. The access control circuit is also configured to grant access to the OTP storage element in response to an access request only when the timer has expired and the count value is less than a predetermined count threshold.

### FIELD

The field of the invention relates to a computer processing systems and in particular to constraining access to one time programmable memory elements.

### RELATED ART

One-time programmable (OTP) memory elements permit data to be written only once and are used to retain data in digital electronic devices even upon loss of power. OTP memory is used in applications where reliable and repeatable reading of data is required. Examples include boot code, encryption keys and configuration parameters for analog, sensor or display circuitry, among others.

OTP elements may be programmed by a “burning” process that uses high current. Reliability is typically only guaranteed for a limited number of accesses, such as read accesses. Repeated use of an OTP device, also referred to as “aging”, may eventually cause some of the OTP memory elements to return to an unprogrammed value, effectively “healing” a programmed element or it may eventually cause some of the OTP memory elements to return unreliable read values upon read accesses. For example, the reliability of an OTP memory may not be guaranteed after a specified number of read accesses due to read current causing electron migration and self-healing of the OTP memory element.

An attacker could take advantage of these effects by repeatedly selectively accessing a limited set of the OTP memory elements or selectively trigger mechanisms which end in an access as consequence, causing them to wear out while leaving other memory elements unchanged. This could allow an attacker to change the security status of a circuit and retrieve sensitive information (e.g. cryptographic keys or other sensitive information).

### BRIEF DESCRIPTION OF THE DRAWINGS

The present technology may be better understood, and its numerous objects, features, and advantages made apparent to those skilled in the art by referencing the accompanying figures.

FIG. 1 illustrates a block diagram of a processing system in accordance with selected embodiments of the invention.

FIG. 2 illustrates a block diagram of an embodiment of components included in an OTP controller that can be used in the processing system of FIG. 1.

FIG. 3 illustrates a timing diagram of a system reset/restart events in combination to access OTP memory using an access delay timer circuit in the OTP controller of FIG. 2 in accordance with selected embodiments.

FIG. 4 illustrates a timing diagram of a system reset/restart events in combination to access OTP memory using an access control circuit in the OTP controller of FIG. 2 in accordance with selected embodiments.

FIG. 5 illustrates examples of timer and counter values associated with security critical storage elements that can be used in the OTP controller of FIG. 2 in accordance with selected embodiments.

The use of the same reference symbols in different drawings indicates similar or identical items unless otherwise noted. The figures are not necessarily drawn to scale.

### DETAILED DESCRIPTION

Embodiments of systems and methods are disclosed that help prevent one time programmable (OTP) memory elements from premature aging due to repeated accesses, such as read accesses, that may otherwise compromise reliability and security of data stored in the OTP memory element. An OTP controller includes an access delay timer circuit that limits access after reset, and after a successfully executed access, for a fixed duration of time. An access control circuit of the OTP controller limits the number of accesses per reset phase by waiting until an access delay timer expires before another access is possible. These timer and counter features cannot be circumvented by causing a reset, powering-down the circuit, or otherwise restarting operation of the circuit. The OTP controller helps to prevent repeated accesses over a short amount of time to prematurely age some of the OTP elements, which could compromise security and operation of the system and allow unauthorized access to data in the other OTP elements.

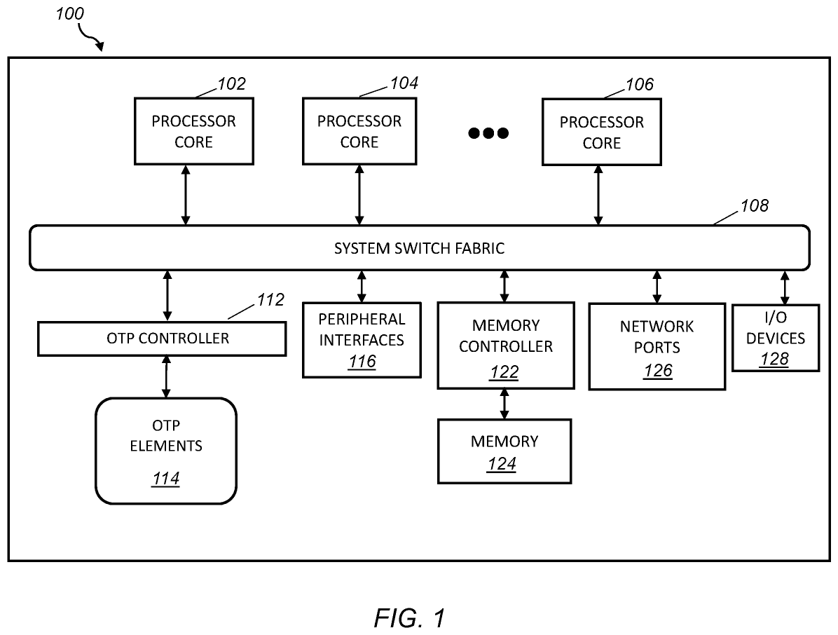

Referring to FIG. 1, a simplified block diagram illustrating an example of a multi-core processing system 100 is shown that can be used to implement embodiments of the present invention. Processing system 100 includes one or more processor cores 102, 104, 106, system switch fabric 108, OTP controller 112, OTP elements 114, peripherals 116, memory controller 122, memory device 124, network ports 126, and input/output (I/O) ports 128. Switch fabric 108 communicatively couples all illustrated components 102-128 of multi-core processing system 100.

Processing cores 102, 104, 106 include computer processor circuitry capable of performing functions that may be implemented as software instructions, hardware circuitry, firmware, or a combination of software, hardware and firmware. Operations and functions may be performed under the control of an operating system. One or more instances of software application code may be executed at the same time. Application code being executed by processing cores 102, 104, 106 may access data and instructions in OTP elements 114 and memory 124 via system switch fabric 108 and respective OTP controller 112 and memory controller 122. Processing cores 102, 104, 106 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. In addition or in the alternative, processing cores 102, 104, 106 may be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processing system 100 can also include one or more network ports 126 configurable to connect to one or more networks, which may likewise accessible to one or more remote nodes. The remote nodes can include other applications processors, devices or sensors that can exchange information with processing system 100.

System switch fabric 108 routes requests and responses between CPUs 102, 104, 106 and OTP controller 112, peripheral interfaces 116, memory controller 122 and I/O devices 128. OTP controller 112 can operate to initially program OTP elements 114 and to access data in OTP elements 114.

Peripherals interface(s) 116 are communicatively coupled to system switch fabric 108. Peripheral interfaces 116 can include, for example, circuitry to perform power management, flash management, interconnect management, USB, and other PHY type tasks. A variety of peripheral devices (not shown) such as a mouse, keyboard, printer, display monitor, external memory drives, cameras, and lights, among others, can be coupled to processing system 100 via peripheral interfaces 116.

Memory 124 may include one or more volatile storage (or memory) devices such as random access memory (RAM), dynamic RAM (DRAM), synchronous DRAM (SDRAM), static RAM (SRAM), or other types of storage devices. In addition or in the alternative, memory 124 may include non-volatile memory, such as read only memory (ROM), electrically erasable programmable ROM, flash memory, or the like. In whatever form, memory 124 may store information including sequences of instructions that are executed by the processing device or any other device. For example, executable code and/or data, in including but not limited to an operating system, device drivers, firmware (e.g., input output basic system or BIOS), and/or applications can be loaded in the memory and executed by processor cores 102, 104, 106.

OTP elements 114 can be implemented using electronic embedded fuses, read only flash devices, magnetoresistive random access memory, or other storage elements that may become unreliable once a specified number of accesses is exceeded.

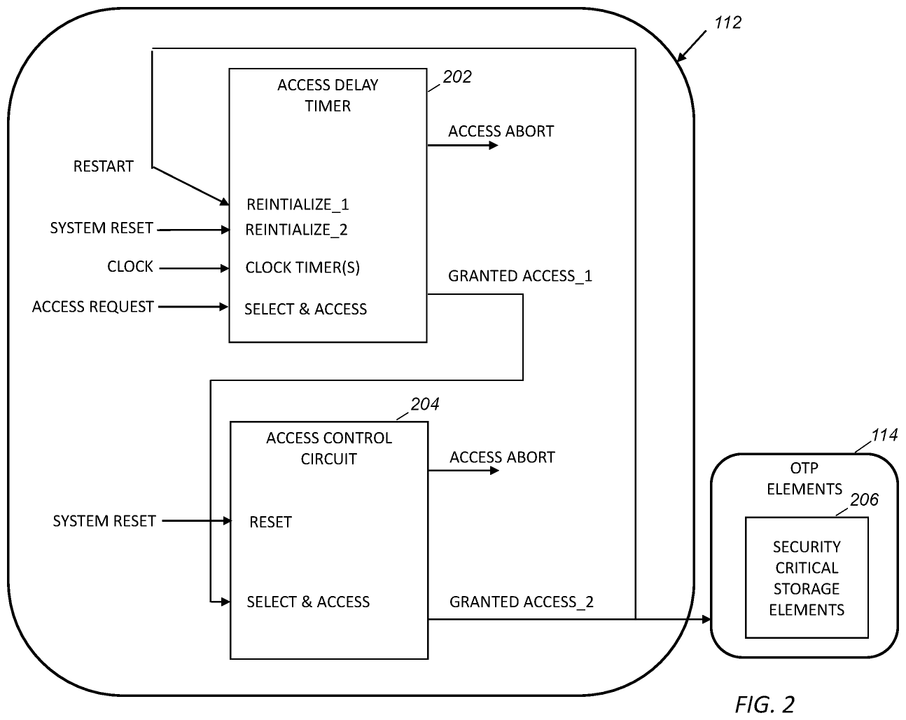

Referring to FIGS. 1 and 2, FIG. 2 illustrates a block diagram of an embodiment of OTP controller 112 that can be used in processing system 100 of FIG. 1. OTP controller 112 includes access delay timer circuit 202 and access control circuit 204. Access delay timer circuit 202 receives a restart input from access control counter circuit 204. Other inputs to access delay timer circuit 202 include system reset signal, clock signal, and access request. The system reset signal may be provided by one or more internal modules of processing system 100, such as CPUs 102, 104, 106 or other modules capable generating a reset signal, and may be asserted during power up, reboot, or reset triggers from outside processing system 100. Processing system 100 can include a master clock circuit (not shown) to provide a clock signal to CPUs 102, 104, 106 and other components in processing system 100. Access request signals may be sent by CPUs 102, 104, 106 when information from OTP elements 114 is needed or contents of OTP elements 114 is to be changed.

In many instances, OTP elements 114 are guaranteed to be reliable for a limited number of accesses. For example, electronic embedded fuses may be guaranteed to hold data reliably up to 20 million accesses. After that, the data may become unreliable or unstable if any self-healing effects have started to occur. To limit the number of accesses over the life of a product, data stored in OTP elements 114 is typically accessed at start up and a copy of data is placed in temporary storage, such as a group of flip flop circuits, while the device is operating. The data in OTP elements 114 can therefore be considered reliable for hundreds, even thousands, of years even in devices that are turned on and off several times a day. On the other hand, the reliability of the data in OTP elements 114 could be compromised, either accidentally or intentionally, within a matter of hours by accessing OTP elements 114 repeatedly past the number of guaranteed reliable accesses. In the event of an attack, a large number of access requests may be sent to prematurely age OTP elements 114 and gain access to security critical storage elements 206 and/or other OTP elements 114, or with the intent to alter them by provoking the aging process. For example, if the reliability of OTP elements 114 may be compromised after 20 million accesses, and OTP elements 114 are accessed every millisecond, then it would only take 5-6 hours to reach the guaranteed number of accesses. Therefore, limiting the number of accesses allowed within a specified time period, and/or over a number of accesses, will significantly extend the amount of time data in OTP elements 114 may be relied upon and the security of processing system 100 protected.

The clock signal is used to operate a clock timer, and the clock timer is used to deny or abort access requests until the timer expires. Once the timer expires and an access request is granted, the timer resets to an initial value and once again aborts access requests until the timer expires. In this way access requests for a security critical storage element(s) 206 cannot take place more frequently than defined by the clock timer. Forced reset triggers may be used during an attack that will lead to continuous reset cycles of processing system 100, however, the periodicity of allowed accesses is still limited by the clock timer and not the reset triggers.

Access delay timer circuit 202 outputs an access abort signal that is used to indicate the access request is denied because a required amount of time has not passed since the last system reset or access to OTP elements 114. Access delay timer circuit 202 also outputs a granted_access_1 signal that is provided as an input to access control circuit 204. The granted_access_1 signal is asserted when a request to OTP elements 114 is made and sufficient time has elapsed on the clock timer since the last access request was granted to allow another access to OTP elements 114, provided conditions for granting access are also met in access control circuit 204. Once the granted_access_1 signal is asserted, the clock timer is reinitialized to an initial value. The clock timer may be configured to increment until a threshold value is reached, or decrement until an initial value reaches a predetermined value. Whether clock timer increments or decrements, at least a prespecified amount of time will need to elapse before access to security critical storage elements 206 is granted, provided conditions for granting access are also met in access control circuit 204.

Access control circuit 204 includes a first input to receive the system reset signal that is used to reset a counter value. Alternatively, the value of the counter may be retained between non-system resets if the counter has not reached the specified value. A select and access input in access control circuit 204 receives the granted_access_1 signal from access delay timer 202. Access control circuit 204 generates two output signals including an access abort signal and a granted_access_2 signal. The access abort signal is asserted when access control circuit 204 determines that the allowable number of access requests has been exceeded since the last system reset. In one implementation, the granted_access_2 signal is asserted when the granted_access_1 signal is asserted by access delay timer 202 and the allowable number of access requests since the last reset has not been exceeded. In another implementation, the granted_access_2 signal may be asserted when either the granted_access_1 signal is asserted or the allowable number of access requests since the last reset has not been exceeded.

The granted_access_2 signal is provided as an input to access delay timer circuit 202 and can be used to reinitialize the access delay timer with a predetermined maximum timer value and to restart the clock timer to prevent further access to one or more of OTP elements 114 before a specified amount of time has passed. The granted_access_2 signal is also shown as being provided as a signal input to OTP elements 114 to indicate access to the OTP elements 114 specified in the access request has been enabled when the granted_access_2 signal is asserted. Once access has been granted, the counter value can be reinitialized and begin timing another period for denying access to OTP elements 114. If the timer reaches a minimum value where access to OTP elements 114 is allowed, the timer can continue incrementing or decrementing past the prespecified value instead of being reset to an initial value.

When the reset event comprises the restart, the access delay timer can be configured to re-initialize the timer with a first timer value (shown as REINITIALIZE_1). When the reset event comprises the system reset, the access delay timer can be configured to initialize the timer with a second timer value (shown as REINITIALIZE_2). The first timer value and the second timer values can be independent timer values.

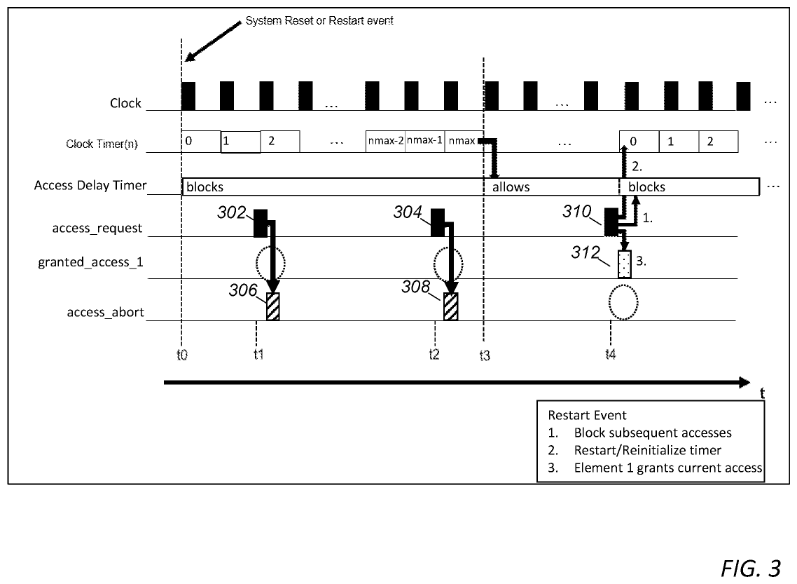

FIG. 3 illustrates a timing diagram of reset/restart events using access delay timer 202 in OTP controller 112 of FIG. 2 in accordance with selected embodiments. A first reset/restart event occurs at time to. The reset/restart event can occur based on a system reset signal or a restart signal (based on the granted_access_2 signal) from access control circuit 204 (FIG. 2). From time to through time t3, a clock timer increments or decrements according a preselected number of clock cycles over which access to OTP elements 114 is blocked. FIG. 3 shows two blocked attempts to access OTP elements 114, a first attempt 302 between times t1 and t2, and a second attempt 304 between times t2 and t3. Attempts 302 and 304 are blocked and respective access_abort indicators 306, 308 are set because a required amount of time has not elapsed since the last system reset, or since the last access was granted to OTP elements 114. At time t3, the clock timer reaches the specified amount of time required to allow access to OTP elements 114, as indicated by the arrow extending from the n_max clock timer value to Access Delay Timer(n) blocks or allows access trace on FIG. 3. Access request 310 is made at time t4 and is allowed because the clock timer has exceeded the amount of time required between accesses. Clock timer is reset so further access requests are blocked until the required amount of time between accesses of OTP elements 114 elapses. Granted_access_1 signal is asserted (see 312), no access abort is asserted and may be provided to access control circuit 204. Alternatively, logic in access control circuit 204 may be bypassed and access may be granted to OTP elements 114 based on sufficient time elapsing on the clock timer alone. Further accesses of OTP elements 114 are blocked until the clock timer once again reaches a minimum amount of time between accesses.

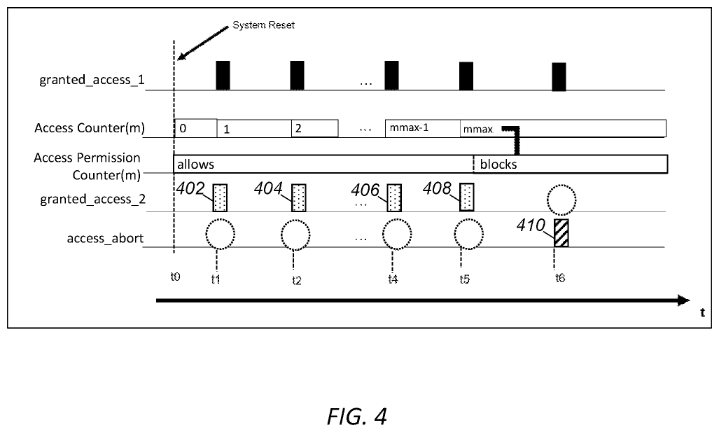

FIG. 4 illustrates a timing diagram of a reset event using access control circuit 204 in OTP controller 112 of FIG. 2 in accordance with selected embodiments. Access control circuit 204 increments an access counter each time OTP elements 114 are accessed. Accesses to OTP elements 114 may be allowed by asserting the granted_access_2 signal up to specified number of times within a specified time period, as tracked by the clock timer. After the specified number of accesses is reached, the granted_access_2 signal can no longer be asserted. In FIG. 4, the granted_access_1 signal is asserted at times t1, t2, t4, t5 and t6. OTP elements 114 are accessed four times as indicated by elements 402, 404, 406, 408 at respective times t1, t2, t3, and t4 until the access counter reaches a maximum allowed value at time t5. During these four accesses, an access_abort signal is not asserted. Note that the access counter can have any suitable limit, even a limit of just one access per startup/reset. After time t5, further access requests, such as access request 410, are blocked and will lead to an access_abort assertion while the access counter is at the maximum allowed value even though the clock timer in access delay timer 202 (FIG. 2) has asserted the granted_access_1 signal. The access_abort signal can be asserted in case the access control circuit denied the access and provided to other components in processing system 100 as an alert that access to OTP elements 114 have been attempted but are denied. Processing system 100 may then take further action to determine the cause of the attempts to access OTP elements 114 and allow them for suitable purposes, or escalate the alert to take suitable steps, if the access attempts are not legitimate. The access counter can be reset upon a system reset or power-down event.

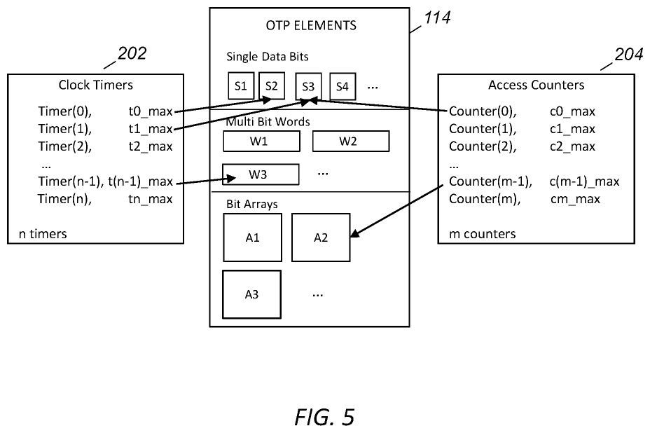

FIG. 5 illustrates examples of timer and counter values associated with security critical storage elements 206 that can be used in OTP controller 112 of FIG. 2 in accordance with selected embodiments. OTP controller 112 may be configured with one or more access delay timers 202 and access control circuits 204. For example, there may be an access delay timer 202 and access control circuit 204 for each OTP element 114. Alternatively, OTP elements 114 may be divided into subgroups, and there may be an access delay timer 202 and access control circuit 204 for one or more of the subgroups. As a further alternative, there may be one access delay timer 202 and one access control circuit 204 for the entire group of OTP elements 114. As another alternative, if there is more than one access delay timer 202 and more than one access control circuit 204, the amount of time for each access delay timer 202, and the threshold or limit for the counter for each access control circuit 204, may be different values for each access delay timer 202 and access control circuit 204. As a further alternative, access to one or more OTP elements 114 may be limited using either an access delay timer 202 or an access control circuit 204, but not both. In addition, a mixture of access restriction using access delay timer 202 and/or an access control circuit 204 to one or more OTP elements 114 can also be used. As another option, access to some OTP elements 114 may not be restricted at all.

As illustrated in FIG. 5, one or more access delay timers 202 and/or access control circuits 204 can be used to limit access to OTP elements 114, and OTP elements 114 may be restricted on a bit, word, multi-word, and/or two or three dimensional array basis. In the example shown, Clock Timer(0) has a maximum limit of t0_max, Timer(1) has a maximum limit of tl_max, Timer(2) has a maximum elapsed time limit of t2_max, Timer(n-1) has a maximum limit of t(n-1)_max, and Timer(n) has a maximum limit of t(n)_max. In addition, Access Counter(0) has a maximum limit of c0_max, Counter(1) has a maximum limit of cl_max, Counter(2) has a maximum elapsed time limit of c2_max, Counter(m-1) has a maximum limit of c(m-1)_max, and Counter(m) has a maximum limit of c(m)_max.

In OTP elements 114, Timer(0) is assigned to single data bit S2, Timer(1) and Counter(0) are assigned to data bit S3. Data bits S1 and S4 have no timer or counter associated with them. Multi-bit words W1 and W2 have no timer or counter associated with them, while Timer(n-1) is assigned to multi-bit word W3. Access to bit arrays A1 and A3 is not restricted by a timer or counter, however, access to bit array A2 is restricted by Counter(m-1). The maximum timer and counter values can be configured in hardware during manufacture to minimize ability to access or tamper with the values. The granularity and type of access, that is, timer and/or counter limits, and the associated data bits, may also be fixed in hardware during manufacture. Other suitable techniques for setting the granularity and maximum counter and timer values can be used, however. Note that FIG. 5 shows just one example of a possible configuration for protecting OTP elements 114 from excessive access attempts. OTP elements 114 may be arranged in other configurations to prevent excessive accesses to additional or fewer OTP elements 114, individually or in groups.

By now it should be appreciated that in some embodiments there has been provided a circuit that can include a one-time programmable (OTP) storage element (114) configured to store a first logic value, an access delay timer (202) configured to initiate a timer in response to a reset event (system reset or restart) with a timer value, and an access control circuit (204) coupled to the access delay timer and the OTP storage element. The access control circuit can be configured to count a number of access requests to the OTP storage element granted by the access control circuit (e.g. green boxes in FIG. 4) and to store the number of granted access requests to the OTP storage element as a count value, and grant access to the OTP storage element in response to an access request only when the timer has expired (assertion of granted access_1) and the count value is less than a predetermined count threshold (assertion of granted access_2).

In another aspect, the access control circuit can be configured to deny access to the OTP storage element in response to the access request when the count value is greater than the predetermined count threshold (e.g. red box in FIG. 4).

In another aspect, the access control circuit can be configured to reset the count value to an initial count value in response to a system reset.

In another aspect, the reset event can comprise one of a restart performed in response to the access request being granted by the access control circuit (e.g. when granted access_2 is negated) or a system reset.

In another aspect, when the reset event comprises the restart, the access delay timer can be configured to initiate the timer with a first timer value, and when the reset event comprises the system reset, the access delay timer can be configured to initiate the timer with a second timer value. The first timer value and the second timer values can be independent timer values.

In another aspect, when the reset event comprises the restart, the access control circuit can be configured to not reset the count value. For example, the counter may only be reset with a system reset and not with a restart upon negating the granted_access_2 signal.

In another aspect, the reset event can comprise a system reset.

In another aspect, the access delay timer can be configured to abort the access request when the access request is received prior to the timer expiring, in which the aborted access request is not provided to the access control circuit, for example, elements 306, 308 in FIG. 3.

In another aspect, the access delay timer can be configured to provide the access request to the access control circuit when the access request is received after the timer expires, for example, when the granted_access_l signal is asserted.

In another aspect, the access requests granted by the access control circuit can comprise read access requests.

In another aspect, the OTP storage element can comprise an embedded fuse.

In another aspect, the OTP storage element can comprise a plurality of OTP storage cells each configured to store a corresponding logic value.

In another aspect, the circuit can further comprise, for example, when there is separate circuitry for two different OTP elements, a second OTP storage element configured to store a second logic value, a second access delay timer configured to initiate a second timer in response to a second reset event with a second timer value, and a second access control circuit coupled to the second access delay timer and the second OTP storage element. The second access control circuit can be configured to count a number of access requests to the second OTP storage element granted by the second access control circuit and to store the number of granted access requests to the second OTP storage as a second count value, and grant access to the second OTP storage element in response to an access only when the second timer has expired and the second count value is less than a second predetermined count threshold.

In further selected embodiments, a method can comprise initiating a timer with a first timer value and setting a count value to an initial count value. The count value can represent a number of read accesses performed on a one-time programmable (OTP) storage element. After initiating the timer, a read access request can be received for the OTP storage element. When the access request is received after the timer is expired (e.g. asserting granted access_1), access to the OTP storage element may be granted only when the count value is less than a predetermined count threshold (e.g. asserting granted access_2). In response to granting access, the count value can be updated, and the timer can be reinitialized with a second timer value. This second timer value may or may not be the same as the first timer value.

In another aspect, the method can further comprise, when the access request is received after the timer is expired (e.g. asserting granted_access_1), access to the OTP storage element can be denied when the count value is greater than the predetermined count threshold (e.g. timer is expired, but count is too much).

In another aspect, the method can further comprise, when the access request is received prior to the timer expiring, aborting the access request.

In another aspect, initiating the timer with the first timer value and the setting the count value to the initial count value can be performed in response to a system reset.

In another aspect, the second timer value can be different that the first timer value.

In still further selected embodiments, a method can comprise initiating a timer with a first timer value. After the initiating the timer, a read access request can be received for a one-time programmable (OTP) storage element. When the access request is received after the timer is expired, access to the OTP storage element can be granted in response to the access request and the timer can be re-initialized with the first timer value. When the access request is received prior to the timer expiring, the access request can be aborted.

In another aspect, when the access request is received after the timer expired and access to the OTP storage element is granted in response to the access request, all accesses to the OTP storage element can be blocked until the timer subsequently expires.

The flowchart and block diagrams in the Figures illustrate the architecture, functionality, and operation of possible implementations of systems and methods according to various embodiments of the present invention. In this regard, each block in the flowchart or block diagrams may represent a module, segment, or portion of hardware, firmware, and/or software code comprising one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that embodiments of the invention are solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles. As will be appreciated by one skilled in the art, aspects of the present invention may be embodied as a system, method or product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Aspects of the present invention are described hereinabove with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. In certain implementations, a system on a chip or SOC may be implemented.

The term “coupled,” as used herein, is not intended to be limited to a direct coupling or a mechanical coupling.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A circuit comprising:
a one-time programmable (OTP) storage element configured to store a first logic value;
an access delay timer configured to initiate a timer in response to a reset event with a timer value; and
an access control circuit coupled to the access delay timer and the OTP storage element, wherein the access control circuit is configured to:
count a number of access requests to the OTP storage element granted by the access control circuit and to store the number of granted access requests to the OTP storage element as a count value, and
grant access to the OTP storage element in response to an access request only when the timer has expired and the count value is less than a predetermined count threshold.

2. The circuit of claim 1, wherein the access control circuit is configured to deny access to the OTP storage element in response to the access request when the count value is greater than the predetermined count threshold.

3. The circuit of claim 2, wherein the access control circuit is configured to reset the count value to an initial count value in response to a system reset.

4. The circuit of claim 1, wherein the reset event comprises one of a restart performed in response to the access request being granted by the access control circuit or a system reset.

5. The circuit of claim 4, wherein when the reset event comprises the restart, the access delay timer is configured to initiate the timer with a first timer value, and when the reset event comprises the system reset, the access delay timer is configured to initiate the timer with a second timer value, wherein the first timer value and the second timer values are independent timer values.

6. The circuit of claim 4, wherein when the reset event comprises the restart, the access control circuit is configured to not reset the count value.

7. The circuit of claim 1, wherein the reset event comprises a system reset.

8. The circuit of claim 1, wherein the access delay timer is configured to abort the access request when the access request is received prior to the timer expiring, in which the aborted access request is not provided to the access control circuit.

9. The circuit of claim 8, wherein the access delay timer is configured to provide the access request to the access control circuit when the access request is received after the timer expires.

10. The circuit of claim 1, wherein the access requests granted by the access control circuit comprise read access requests.

11. The circuit of claim 1, wherein the OTP storage element comprises an embedded fuse.

12. The circuit of claim 1, wherein the OTP storage element comprises a plurality of OTP storage cells each configured to store a corresponding logic value.

13. The circuit of claim 1, further comprising:
a second OTP storage element configured to store a second logic value;
a second access delay timer configured to initiate a second timer in response to a second reset event with a second timer value; and
a second access control circuit coupled to the second access delay timer and the second OTP storage element, wherein the second access control circuit is configured to:
count a number of access requests to the second OTP storage element granted by the second access control circuit and to store the number of granted access requests to the second OTP storage as a second count value, and
grant access to the second OTP storage element in response to an access only when the second timer has expired and the second count value is less than a second predetermined count threshold.

14. A method comprising:
initiating a timer with a first timer value and setting a count value to an initial count value, wherein the count value represents a number of read accesses performed on a one-time programmable (OTP) storage element;
after the initiating the timer, receiving a read access request for the OTP storage element;
when the access request is received after the timer is expired, granting access to the OTP storage element only when the count value is less than a predetermined count threshold, and in response to the granting access:
updating the count value, and
re-initiating the timer with a second timer value.

15. The method of claim 14, further comprising:
when the access request is received after the timer is expired, denying access to the OTP storage element when the count value is greater than the predetermined count threshold.

16. The method of claim 15, further comprising:
when the access request is received prior to the timer expiring, aborting the access request.

17. The method of claim 14, wherein the initiating the timer with the first timer value and the setting the count value to the initial count value are performed in response to a system reset.

18. The method of claim 14, wherein the second timer value is different that the first timer value.

19. A method comprising:
initiating a timer with a first timer value;
after the initiating the timer, receiving a read access request for a one-time programmable (OTP) storage element;
when the access request is received after the timer is expired, granting access to the OTP storage element in response to the access request and re-initiating the timer with the first timer value;
when the access request is received prior to the timer expiring, aborting the access request.

20. The method of claim 19, wherein when the access request is received after the timer expired and access to the OTP storage element is granted in response to the access request, blocking all accesses to the OTP storage element until the timer subsequently expires.
